(19) United States
(12) Patent Application Publication
(10) Pub. No.: US 2006/0068340 A1
(43) Pub. Date: Mar. 30, 2006

(54) High bromide{111} tabular grain emulsions with improved dispersity

(76) Inventors: Gertjan Bogels, Tilburg (NL); Jan Bastiaan Boustra, Bilthoven (NL); Yuzo Toda, Asaka-Shi Senzui (JP)

Correspondence Address: ROGER PITT;KIRKPATRICK & LOCKHART NICHOLSON GRAHAM LLP, 599 LEXINGTON AVENUE, 33RD FLOOR, NEW YORK, NY, 10022-6030, US

(21) Appl. No.: 10/538,962

(22) PCT Filed: Dec. 19, 2003
(86) PCT No.: PCT/NL03/00914

§ 371 Date: Sep. 14, 2005

(30) Foreign Application Priority Data
Dec. 19, 2002 (EP) 02080452.2

(51) Int. Cl. G03C 1/005; G03C 1/494

(52) U.S. Cl. 430/567

(57) ABSTRACT

The invention relates to tabular silver halide emulsions that are useful in the field of photography and particularly to a process for preparing the tabular silver halide emulsions. The process of the invention relates to tabular grain formation process which is carried out in the presence of a compound which has a preferred adsorption to {111} crystal faces as compared to {100} crystal faces. The parameter for the preferred adsorption follows from a modified Kubelka-Munk method.

### FIELD OF THE INVENTION

The invention relates to {111} tabular silver halide emulsions that are useful in the field of photography and particularly to a process for preparing the {111} tabular silver halide emulsions.

### BACKGROUND OF THE INVENTION

{111} Tabular silver halide grains having parallel twin planes (hereinafter referred to as “{111} tabular grains”) have the following photographic properties:

1) Since they have a large ratio of the surface area to the volume (hereinafter called “specific surface area”), a great amount of a sensitizing dye can be adsorbed to their surface. As a result, they have color sensitized-sensitivity, which is high relative to their intrinsic sensitivity.

2) When an emulsion containing the {111} tabular grains is coated and dried, the planes of the grains are arranged in parallel on the surface of a support, whereby the coated layer can be so thin that sharpness is good.

3) In the case of same sensitivity, the amount of silver coated can be smaller than in the case of using a non-{111} tabular grain emulsion, and the sensitivity/graininess ratio is therefore high.

4) They are highly resistant to natural radiation.

Having these many advantages, the {111} tabular grains have hitherto been used in many commercially produced photographic materials. In those photographic products, a high aspect ratio is an important feature of tabular grains to demonstrate their advantages fully. However, tabular grains having a high aspect ratio have a broad distribution of the diameter of the projected area. This is an important drawback of the existing tabular grain technology. As therefore, the {111} tabular grains are disadvantageous in the following respects:

1) They cannot be expected to achieve hard gradation (i.e., so-called high gamma) in a characteristic curve.

2) When {111} tabular grain populations consist of large grains and small grains, optimal chemical sensitization cannot be realised since the best conditions for chemical sensitization of the large grains differ from those for chemical sensitization of the small grains.

3) A multi-layered structure which has an upper layer formed of monodisperse large grains and a lower layer formed of monodisperse small grains utilizes light more efficiently and hence has higher sensitivity than a single layered structure which has an emulsion coating layer which contains large grains and small grains together. In case of heterodisperse {111} tabular grain emulsions this advantage of an allocation of the different grain sizes to separated layers cannot be utilized well.

In general, {111} tabular grains are formed in three subsequent processes, i.e., the nucleation, the ripening, and the grain growth process.

In the nucleation process a heterodisperse mixture of tabular “nuclei” and non-tabular “nuclei” is prepared.

The next ripening process is designed in such a way that all non-tabular grains are dissolved without reducing the total number of tabular grains, and finally the grain growth process has the function to increase the sizes of tabular grains to their finally desired sizes.

Several attempts have been made to improve the homodispersity of {111} tabular grain populations.

One way has been the use of a special vessel for the nucleation step, separated from the ripening or growth steps as described in, for example, WO90/1462, JP-5341414-A, JP-5061134-A, EP1,014,175 or U.S. Pat. No. 6,214,532. However, the use of additional tanks and addition systems is absolutely not desired from an economical or from a process control viewpoint and introduces additional sources of process variations.

Another attempt to improve the homodispersity is by introducing polymers other than gelatin during nucleation as described in for example U.S. Pat. No. 5,147,771-773, U.S. Pat. No. 5,629,142 or U.S. Pat. No. 5,693,459. The disadvantage of using polymers is that the average aspect ratio of {111} tabular grains decreases dramatically so that advantage of using {111} tabular grains diminishes.

It can be concluded that increasing the average aspect ratio of the {111} tabular grains leads to a wider grain size distribution. In the current art there is a need for techniques to prepare emulsions that are {111} tabular and that combine a high average aspect ratio with a narrow grain size distribution.

Hydrolysed gelatins are mentioned in several publications. EP 0,610,796 describes the use of low molecular weight gelatins in relation to cubic silver chloride crystals. Moll refers to the effect of enzymatically hydrolysed gelatins in relation to the growth of cubic silver chloride crystal in ‘Photographic gelatin’, Academic Press Inc, 1972, 207-217. Also De Brabandere et al. in ‘Photographic Gelatin II’, Academic press Inc, 1976, 335-346, describes the use of small peptizers obtained by enzyme treatment of gelatins for cubic crystals. It is concluded that as a result the grain size distribution gets worse.

It should be noted that cubic crystals have a mechanism of growth that is completely different from {111} tabular crystals, and that experimental data on the effect of hydrolysed gelatins on the homodispersity of cubic crystal populations are not relevant for their use in {111} tabular crystal grain formation processes. Cubic crystals are bounded by {100} faces where as the large top and bottom surfaces of tabular crystals consists of {111} surfaces.

### SUMMARY OF THE INVENTION

It is the object of this invention to provide a {111} tabular silver halide emulsion with an excellent grain size distribution.

A further object of this invention is to provide a {111} tabular silver halide emulsion with an excellent grain size distribution without introducing additional process steps.

Another object of the invention is to provide a silver halide emulsion with thin {111} tabular crystals with a high aspect ratio having excellent sensitivity and graininess.

Surprisingly, it was found that a preferred adsorption to {111} surfaces of polymers added in the tabular grain formation process was of influence on the grain size distribution. More precisely, it was found that the objects of the invention could be reached by a process in which polymers with a preferred adsorption to {111} surfaces over {100} surfaces was added.

Additionally, it was found which polymer structures showed such a preferred adsorption to {111} surfaces over {100} surfaces, measured at pH=9.

More precisely, the objects of the invention could be reached by a process for producing a {111} tabular silver halide emulsion in which an aqueous solution of a silver salt is combined with an aqueous solution of a halide salt forming {111} tabular silver halide grains in the presence of a water-soluble polymeric compound which has a preferred adsorption to {111} crystal faces of −3 or less, measured at pH=9, as determined by subtracting the value for the adsorption to {111} crystal faces from the value for the adsorption to {100} crystal faces, said values being determined by the modified Kubelka-Munk method as described in T. Tani J. Imag. Sc 29 (1985) vol 29,165, in the presence of the water-soluble polymeric compound.

The tabular grain formation process comprises the steps of nucleation and ripening. Most precise the water-soluble polymeric compound is added during the nucleation step. In one embodiment preferably the pH during the nucleation step is less than 6. In a further embodiment preferably the pH during the nucleation step is 6 or higher. Preferably the pH of the nucleation step is maintained during the ripening step.

Further the invention relates to a {111} tabular silver halide emulsion produced in said process, having an improved homodispersity that is expressed as RDA, the ratio between the distribution width at half peak height in nanometers and the average aspect ratio.

In a further aspect the invention relates to a {111} tabular silver halide emulsion wherein at least 60% of the total projected grain area of said silver halide grains are {111} tabular silver halide grains with a silver bromide content of at least 50% obtainable with the method according to the invention.

Also the invention relates to photographic material comprising on a support at least one layer comprising a {111} tabular silver halide emulsion according to the invention.

### DESCRIPTION OF THE INVENTION

The invention is directed to {111} tabular high bromide silver halide emulsions wherein at least 60% of the total projected grain area of said silver halide grains are {111} tabular silver halide grains with an average aspect ratio of 6 to 40 and a thickness of less than 0.2 micron with improved homodispersity. Preferably such an emulsion has a homodispersity of less than 18 expressed as RDA, preferably less than 16.

The term “tabular grains” indicates grains having two parallel grain faces which are clearly larger than any remaining grain face. Tabular grain emulsions are emulsions in which tabular grains account for more than 50% of the total grain projected area.

The aspect ratio is a value obtained by dividing the diameter of the largest surface area of the individual tabular grain by the thickness thereof. The word “diameter,” used here, means the diameter of a circle that has an area equal to the projected area of the grain, which is determined through microscope or electron microscope observation. Hence, an aspect ratio of 8 or more means that the diameter of that circle is 8 or more times greater than the thickness of the grain.

If the average aspect ratio is high, the polydispersity becomes also higher and gradation of the silver halide emulsion becomes soft. In addition, pressure marks will occur. On the other hand, if the average aspect ratio is too low, the excellent properties in terms of sensitivity of the tabular grain emulsion will be diminished.

An example of methods of measuring the aspect ratio is the replica method in which the equivalent-circle diameter (ECD) and thickness of each grain are detected from the photograph of that grain which has been taken by a transmission electron microscope. In this method, the thickness is calculated from the length of the shadow of a replica.

The variation coefficient of grain size can be expressed as a value obtained by dividing the standard deviation of the equivalent-circle diameters of projected areas of all silver halide grains, by the average diameter of the silver halide grains. However, when expressed in this manner the relation between the aspect ratio and grain size variation is not shown, since the grain thickness is ignored. Therefore, homodispersity is better expressed as RDA, the ratio between the distribution width at half peak height in nanometers and the average aspect ratio.

The tabular grains having high aspect ratios can be formed using various methods. For instance, the grain formation methods disclosed in U.S. Pat. Nos. 5,496,694 and 5,498,516 can be adopted in the invention. Further, the tabular grains having ultrahigh aspect ratios can be formed using the grain formation methods disclosed in U.S. Pat. Nos. 5,494,789 and 5,503,970. Using those methods, the tabular grains with high aspect ratios suffer from a high heterodispersity.

In the method of the invention the addition of a polymer with a preferred adsorption to the {111} surfaces of the silver halide grains increases the homodispersity. Usually in silver halide emulsions preparation processes gelatines are used. In the method of the invention the nucleation step is preferably done in the presence of a water-soluble polymeric compound with a preferred adsorption to {111} faces measured at pH=9, that is selected from a natural gelatine, a synthetic gelatine, a modified gelatine and a recombinant gelatine.

In forming homodisperse tabular grains with high average aspect ratios, it is important to produce parallelly twinned crystal nuclei of small sizes in a short time. For the production of such nuclei, it is desirable that the nucleation be carried out in a short time at a low temperature in the presence of a reduced amount of gelatin.

In the method of the invention, special gelatin-like polymers of a low molecular weight are preferred. In one embodiment the invention comprises nucleation in the presence of a gelatin-like polymer having a molecular weight of less than 50 kilo Dalton, most preferably from 3 to 25 kilo Dalton.

In the method of the invention preferably the water-soluble polymeric compound is added simultaneously with the silver salt and the halide salt in the nucleation step instead of adding silver- and halide salt in a dispersion medium in which the polymeric compound is already present. This can be performed in particularly by mixing the polymeric compound with the aqueous solution of halide salt used for nucleation. This is mixed with the aqueous solution of a silver salt in a nucleation chamber, which is located in a larger vessel. When special gelatines are used in the method of the invention, preferably at most 80% of the nucleation peptizer is the special gelatin having the preferred {111} adsorption as defined above, the remaining at least 20% of the nucleation peptizer consisting of conventional gelatins.

In case the polymeric compound is a polypeptide, it preferably comprises an amino acid selected from arginine, lysine, hydroxylysine and histidine as the carboxy-terminal amino acid. In this case the nucleation step and preferably ripening step are preferably carried out at a pH of 6 or higher, more preferably at a pH higher than 7, most preferably at a pH between about 8 and 11. A pH higher than 11 can be applied but is less preferred because hydrolysis of the polypeptide may occur.

A single histidine, arginine or lysine located on the N-terminal side of the polypeptide, instead of the C-terminal side, does not have the desired effect to such a large extend. It appears that the presence of a C-terminal carboxyl group is important for the preferred adsorption of the polypeptide to the {111} faces of the tabular grains. However, polypeptides of this invention are not limited to structures with a C-terminal amino acid that contain a free amine group (like histidine, arginine or lysine). A terminal C- or N-side of the polypeptide may also comprise two amino acids within each other's vicinity, one amino acid ‘A’ having a restgroup containing an amine group and one amino acid ‘B’ having a restgroup containing a carboxyl group. These amino acids should preferably not be separated by more than 5 amino acids, preferably by at most 4 amino acids, more preferably by at most 2 amino acids most preferably by at most 1 amino acid. The terminal sides of the polypeptide can also contain more than one amino acid ‘A’ and/or ‘B’.

Such structures can be, for example:
His-Asp-gelatin, His-Gly-Asp-gelatin (C- or N-terminal side)
Arg-Gly-Glu-Pro-His-Asp-gelatin,
Lys-Asp-gelatin-Glu-Arg, His-Asp-gelatin-Glu-Pro-Arg

Preferably the nucleation step is carried out at a pH of 7 or more, preferably at a pH of at least 8, more preferably at a pH between about 8 and 11 in the presence of a polypeptide in which amino acid ‘A’ is arginine or lysine.

Advantageously the compound is present in the nucleation step in an amount of about 0.01 to 0.2 mol per mol silver, preferably 0.05 to 0.1 mol per mol silver.

Preferred low molecular weight gelatin-like polymers for use in the method of the invention can be prepared by subjecting a natural gelatin or modified natural gelatin-like oxidised, phthalated, trimellitated, pyromellitated gelatin—to hydrolysis by specific enzymes like trypsin, which cuts the gelatin next to a lysine or arginine amino acid in the polypeptide chain. Other specific enzymes may be selected from the group comprising acrosin and tryptase and lysyl and endopeptidase and Venobin AB and trypsin and peptidyl-lys metalloendopeptidase.

Low molecular weight gelatin-like polymers can also be prepared synthetically or with recombinant techniques as described in EP 1,014,176, U.S. Pat. No. 5,773,249 and U.S. Pat. No. 5,496,712

The preferred adsorption to {111} faces can be expressed in an adsorption parameter, which parameter is calculated by the method explained in detail in example 1. Preferably the preferred adsorption of the inventive gelatin-like compound is in terms of this parameter lower than −3, more preferably lower than −4 and most preferably lower than −6.

By fully digesting gelatin with trypsin a polypeptide with a MW of about 6.4 kD having a carboxy-terminal arginine or lysine is obtained with a preferred adsorption to the {111} faces of {111} tabular grains.

It is further envisaged that additional amino acids or poly-amino acids comprising Histidine, Lysine, Hydroxylysine or Arginine can be chemically cross-linked to a polypeptide. Methods are described in The Practice of Peptide synthesis, M. Bodansky, A. Bodansky, Splinger-Verlag, Berlin 1984 and Solid Phase Peptide synthesis, J. M. Steward, J. D. Young, San Francisco, W.H. Freeman and Company, 1989).

An additional amino acid that is thus linked to the amine of an amino acid present in a gelatin-like polypeptide could have itself two primary amines available for further cross-linking of (poly)amino acids. Such a structure which provides additional sites for cross-linking is called a spacer and can in this case be any molecule that has a functional group which can be linked to a primary amine of a gelatin-like polymer and has itself at least two free primary amines. Another example of such a spacer is dendrites

It has been found that the presence of a free carboxyl group is advantageous for the formation of homodisperse {111} tabular silver halide crystals. A gelatin having an Arginine or Lysine at the amino-terminal position may be chemically modified in such a way that a free carboxyl groups is introduced in the amino terminal region.

After the nucleation, the nuclei of non-twinned crystals, singly twinned crystals and non-parallel multiply twinned crystals will dissolve by physical ripening in the ripening process step, and only the nuclei of parallel multiply twinned crystals will not dissolve. After this ripening process, supplementary gelatin is added, and the then a soluble silver salt and soluble halide(s) are added, thereby performing the grain growth. As the supplementary gelatin, normal gelatins or gelatins whose amino groups are modified with for example phthalic acid, trimellitic acid or pyromellitic acid can be used.

In another favourable way to affect the grain growth, silver and halide(s) are supplied by the addition of fine grains of silver halide prepared in advance separately or those prepared in a separate reaction vessel at the same time.

The optimization by controlling the temperature, pH, binder content and pBr of reaction solutions and the feeding speeds of silver and halide ions is also of importance in the step of grain growth.

To form silver halide emulsion grains, any of silver bromide, silver chlorobromide, silver iodobromide, silver iodochloride, silver chloride and silver chloroiodobromide can be used in the invention. However, the use of silver iodobromide or silver chloroiodobromide is preferable. When the emulsion grains have faces containing iodide or chloride, these faces may be uniformly distributed inside the grains, or non-uniformly distributed. Other silver salts, such as silver thiocyanate, silver sulfide, silver selenide, silver carbonate, silver phosphate and silver salts of organic acids, may be present as separate grains, or as a component of silver halide grains.

The bromide content in the emulsion grains is at least 80 mole %, preferably at least 90 mole %, of the total amount of halide.

The suitable iodide content in the present emulsion grains is from 1 to 20 mole %, preferably from 2 to 15 mole %, more preferably from 3 to 10 mole % of the total amount of halide. An iodide content lower than 1 mole % is undesirable, because this makes it difficult for the grains to have the effects of intensifying the dye adsorption and increasing the intrinsic sensitivity. The iodide contents higher than 20 mole % are also undesirable, because they generally cause a decrease in development speed.

The {111} tabular silver halide crystals may be host crystals with epitaxially grown guest crystals as described in U.S. Pat. No. 6,337,177. It is desirable that the present silver halide tabular grains have at least one kind of a photographically useful metal ion or complex (hereinafter referred to as “metal (complex) ion”) in their respective insides.

The term “photographically useful metal (complex) ions” means the dopants added to silver halide grains for the purpose of improving the photographic characteristics of a photosensitive silver halide emulsion. The metal (complex) ions added as dopants function as transitional or permanent traps for electrons or positive holes in the silver halide crystals to produce beneficial effects, such as enhancement of sensitivity and contrast, improvement in reciprocity characteristics and improvement in resistance to damage by pressure. Suitable examples of metal ions used for doping the present emulsion grains include the ions of the first to third transition metals, such as iron, ruthenium, rhodium, palladium, cadmium, rhenium, osmium, iridium, platinum, chromium and vanadium, and the ions of amphoteric metals, such as gallium, indium, thallium and lead. In doping the emulsion grains, these metal ions are used in the form of complex salt or single salt. In the case of complex ions, six-coordinate halogeno-complexes and cyano-complexes having halide ions and cyanide ions as ligands are used to advantage. In addition to these complexes, the complexes having organic ligands, such as nitrosyl (NO), thionitrosyl (NS), carbonyl (CO), thiocarbonyl (CS), isocyanato (NCO), thiocyanato (SCN), selenocyanato (SeCN), tellurocyanato (TeCN), dinitrogen (N 2), azido (N3), bipyridyl, cyclopentadienyl, 1,2-dithiolenyl and imidazolyl ligands, can also be used. Examples of other ligands usable for the complexes as dopants include multidentate ligands, such as bidentate ligands (e.g., bipyridyl), tridentate ligands (e.g., diethylenetriamine), tetradentate ligands (e.g., triethylenetetramine) and hexadentate ligands (e.g., ethylenediaminetetraacetato). The coordination number is preferably 6, but it may be 4. Further, the organic ligands disclosed in U.S. Pat. Nos. 5,457,021, 5,360,712 and 5,462,849 can also be used to advantage. In addition, as disclosed in U.S. Pat. No. 5,024,931, it is also desirable to incorporate metal ions as oligomer.

In incorporating metal (complex) ions into silver halide grains, it is important that the size of metal (complex) ion can be incorporated into the lattice of silver halide grains. Further, it is essential to doping silver halide grains that the compounds produced from metal (complex) ions and silver or halide ions are co-precipitated with silver halide. For the co-precipitation, it is necessary that the pKsp (the common logarithm of the reciprocal of the solubility product) of the compound constituted of a metal (complex) ion and silver or halide ion be on the same level as the pKsp of silver halide (silver chloride 9.8, silver bromide 12.3, silver iodide 16.1). Therefore, it is desirable that the pKsp of the compound constituted of a metal (complex) ion and silver or halide ion is from 8 to 20.

The amount of the above-recited metal complex used for doping silver halide grains is generally from 10⁻⁹ to 10⁻² mole per mole of silver halide. To describe it in detail, it is desirable that the metal complexes providing transitional shallow electron traps in the sensitizing step be used in the range of 10⁻⁶ to 10⁻² mole per mole of silver halide; while the metal complexes providing deep electron traps in the sensitizing step be used in the range of 10⁻⁹ to 10⁻⁵ mole per mole of silver halide.

The content of metal (complex) ions in emulsion grains can be confirmed by the atomic absorption spectral analysis, the polarized Zeeman spectroscopic analysis or ICP analysis. The ligands in a metal complex ion can be confirmed by Infrared absorption (especially FT-IR).

The metal (complex) ions as dopant may be incorporated in the surface or inner core of silver halide grains, or in a very shallow surface shell (the so-called subsurface) having a depth reduced to such an extent as not to expose metal ions as disclosed in U.S. Pat. Nos. 5,132,203 and 4,997,751. In other words, the location of a dopant may be chosen depending on the intended purpose. Two or more kinds of metal ions may be used as dopants, and they may be located at the same shell or separate shells. The addition of those compounds may be carried out by previously mixing the metal salt solution with either an aqueous halide solution or an aqueous silver salt solution used for grain formation, or by direct addition of the metal salt solution to the grain formation system. Further, the metal ion-doped fine silver halide emulsion grains may be added. In dissolving a metal salt in an appropriate solvent, such as water, methanol or acetone, it is desirable that the solution be stabilized by the addition of an aqueous solution of hydrogen halide (e.g., HCl, HBr), thiocyanic acid or salts thereof, or alkali halide (e.g., KCl, NaCl, KBr, NaBr). From the same point of view, the addition of an acid or an alkali depending on the intended purpose is also beneficial.

The doping of emulsion grains with metal ions of cyano-complexes sometimes generates cyan by the reaction between gelatin and the cyano-complexes to inhibit the gold sensitization. In such cases, as disclosed, e.g., in JP-A-6-308653, it is desirable that the cyano-complexes be used in combination with compounds having an inhibitory function in the reaction of gelatin with the cyano-complexes. More specifically, it is desirable that the process of or after doping the emulsion grains with the metal ions of cyano-complexes be performed in the presence of metal ions capable of forming coordinate bonds with gelatin, such as zinc ion.

The methods of preparing the present silver halide emulsions mentioned above and other silver halide emulsions usable together therewith are illustrated below.

The silver halide grains used in the invention can be prepared basically in accordance with known methods, namely the methods described in, e.g., P. Glafiddes, Chimie et Physique Photographique, Paul Montel (1967), G. F. Dufin, Photographic Emulsion Chemistry, The Focal Press (1966), V. L. Zelikman, et al., Making and Coating Photographic Emulsion, The Focal Press (1964). More specifically, the emulsions can be prepared in various pH regions, e.g., using an acid, neutral or ammoniacal process. As to the way of feeding reactant solutions, including a solution of water-soluble silver salt and a solution of water-soluble halide, any of a single jet method, a double jet method and a combination thereof can be employed. Further, the so-called controlled double jet method, wherein the addition of reactant solutions is controlled so as to maintain the pAg value at the intended value during the reaction, can be employed to advantage. Furthermore, the method of keeping the pH value constant during the reaction may be employed as well. In forming grains, it is feasible to adopt the method of controlling the solubility of silver halide by changing the temperature, pH or pAg value of the reaction system, but silver halide solvents, such as thioethers, thioureas or thiocyanates, may be added to the reaction system, too. These cases are described in, e.g., JP-B-47-11386 (the term “JP-B” as used herein means an “examined Japanese patent publication”) and JP-A-53-144319.

The preparation of the silver halide grains used in the invention is generally effected by feeding a solution of water-soluble silver salt, such as silver nitrate, and a solution of water-soluble halide, such as alkali halide, into an aqueous solution of water-soluble binder, such as gelatin, under the controlled conditions. In the nucleation phase, the binder is a polymer with a preferred adsorption to the {111} face. After the formation of silver halide grains, it is desirable to carry out the removal of excess water-soluble salts. The excess water-soluble salts can be removed using the noodle washing method which comprises gelling the gelatin solution containing silver halide grains, cutting into strips and washing out the water-soluble salts with cold water, or the flocculation method in which a flocculant, such as an inorganic salt containing a polyvalent anion (e.g., sodium sulphate), an anionic surfactant, an anionic polymer (e.g., sodium polystyrene suffocate) or a gelatin derivative (e.g., an aliphatic acylated gelatin, an aromatic acylated gelatin, an aromatic carbamoylated gelatin), is added to cause the aggregation of gelatin, thereby removing the excess salts. Of these methods, the flocculation method is preferable because it enables rapid removal of excess salts.

In general, it is desirable that the silver halide emulsions used in the invention be chemical sensitized using known sensitization methods alone or in various combinations. The chemical sensitization contributes to conferring high sensitivity, exposure condition stability and storage stability upon the silver halide grains prepared. The chemical sensitization methods used to advantage are a chalcogen sensitization method using a sulphur, selenium or tellurium compound. Examples of a sensitizer usable herein include compounds capable of releasing a chalcogen element as recited above to form silver chalcogenide when added to a silver halide emulsion. The combined use of such sensitizers is desirable from the viewpoint of increasing the sensitivity and suppressing the fog. In addition, it is also desirable to adopt the precious metal sensitization method using gold, platinum, iridium or the like. In particular, the gold sensitization method using chloroauric acid alone or in combination with ions capable of coordinating to gold, such as thiocyanate ion, is advantageous because of its high sensitizing effect. Further high sensitivity can be obtained by the combined use of gold sensitization and chalcogen sensitization.

Another sensitization method used to advantage is the so-called reduction sensitization method wherein reduced silver nuclei are introduced by the use of a compound having moderate reducing power during the grain formation, thereby increasing the sensitivity. Further, the reduction sensitization method of adding an aromatic ring-containing alkinylamine compound at the time of chemical sensitization is favourably used.

In carrying out chemical sensitization, it is also desirable to control the reactivity therein by the addition of various compounds capable of adsorbing to silver halide grains. For the reactivity control, it is especially desirable to adopt the method of adding a nitrogen-containing heterocyclic compound, a mercapto compound or sensitizing dyes, such as cyanine and merocyanine dyes, prior to chalcogen sensitization and gold sensitization. The appropriate reaction conditions for chemical sensitization depend on the intended purpose. Specifically, the temperature is from 30° C. to 95° C., preferably from 40° C. to 75° C.; the pH is from 5.0 to 11.0, preferably from 5.5 to 8.5; and the pAg is from 6.0 to 10.5, preferably from 6.5 to 9.8. The arts of chemical sensitization are described in, e.g., JP-A-3-110555, JP-A-5-241267, JP-A-62-253159, JP-A-5-45833 and JP-A-62-40446. In the chemical sensitization step, it is desirable to form an epitaxial projection part on the grain surface.

The light-sensitive silver halide emulsions used in the invention are desirably subjected to the so-called spectral sensitization to acquire sensitivities in the desired wavelength regions. In particular, photosensitive layers having sensitivities to blue, green and red lights respectively are incorporated in a color photographic material for the purpose of reproducing colors faithful to an original. These color sensitivities are conferred by spectrally sensitizing silver halide with the so-called spectral sensitizing dyes. Such sensitizing dyes include cyanine dyes, merocyanine dyes, complex cyanine dyes, complex merocyanine dyes, holopolar dyes, hemicyanine dyes, styryl dyes and hemioxonol dyes. Examples of these dyes are disclosed in U.S. Pat. No. 4,617,257, JP-A-59-180550, JP-A-64-13546, JP-A-5-45828, JP-A-5-45834 and soon. Those spectral sensitizing dyes are used alone or as a combination of two or more thereof. The combination of dyes is employed for the purpose of controlling the wavelength distribution of spectral sensitivity or obtaining supersensitizing effect. The supersensitizing combination of dyes can achieve the sensitivity materially greater than the sum of the sensitivities achieved by individual dyes. Further, it is also desirable to employ compounds, which can exhibit a supersensitizing effect in combination with a certain sensitizing dye although they themselves do not spectrally sensitize silver halide emulsion or do not absorb light in the visible region. Such supersensitizing compounds include diaminostilbene compounds. Examples thereof are disclosed in U.S. Pat. No. 3,615,641, JP-A-63-23145 and so on. Those spectral sensitizing dyes and supersensitizing compounds may be added to silver halide emulsions at any stage of emulsion-making. Specifically, they may be added to a chemically sensitized emulsion at the time of preparing a coating solution using the emulsion, or their addition to an emulsion may be at the conclusion of, during or prior to chemical sensitization, or they may be added within a period from the completion of grain formation to the start of desalting, during the grain formation or prior to the grain formation. These ways of addition may be adopted independently or as combination of two or more thereof. For achievement of high sensitivity, the addition in steps prior to chemical sensitization is effective. The spectral sensitizing dyes and supersensitizing compounds each can be added in an amount chosen from a wide range depending on the shape and size of emulsion grains and the photographic characteristics intended to be conferred thereby. In general, however, the addition amount ranges from 10⁻⁸ to 10⁻¹ mole, preferably from 10⁻⁵ to 10⁻² mole, per mole of silver halide. Those compounds are dissolved in an organic solvent, such as methanol or fluorinated alcohol, or dispersed into water together with a surfactant and gelatin, and then added to silver halide emulsions.

The silver halide emulsions used in the invention can contain a wide variety of stabilizers for purposes of preventing fogging or heightening stability during storage. Suitable examples of a stabilizer include nitrogen-containing heterocyclic compounds such as azaindenes, triazoles, tetrazoles and purines, and mercapto compounds such as mercaptotetrazoles, mercaptotriazoles, mercaptoimidazoles and mercaptothiadiazoles. The details of these compounds are described in T. H. James, The Theory of the Photographic Process, pages 396-399, Macmillan (1977) and the references cited therein. Of those antifoggants, the mercaptoazoles having an alkyl group containing at least 4 carbon atoms and two or more aromatic groups as substituents are preferably used in the invention. Such antifoggants or stabilizers may be added to silver halide emulsions at any stage of emulsion-making. Specifically, they may be added within a period from the conclusion of chemical sensitization to the start of preparing a coating solution, at the conclusion of, during or prior to chemical sensitization, within a period from the completion of grain formation to the start of desalting, during the grain formation, or prior to the grain formation. These ways of addition may be adopted independently or as combination of two or more thereof. Those antifoggants or stabilizers can be added in an amount chosen from a wide range depending on the halide composition of emulsion grains and the required purpose. In general, however, the addition amount ranges from 10⁻⁶ to 10⁻¹ mole, preferably from 10⁻⁵ to 10⁻² mole, per mole of silver halide.

The aforementioned photographic additives, which are usable in the invention, are described in U.S. Pat. No. 6,337,177 column 15-16.

The tabular crystals may be host crystals with epitaxially grown guest crystals as described in U.S. Pat. No. 6,337,177

The present {111} tabular grains have at least two parallel twinning planes per grain and have a triangular or hexagonal shape the corners of which may be sharp or round. When they have a hexagonal shape, each pair of sides facing each other have outer surfaces parallel to each other.

The twinning plane distance in the present {111} tabular grains may be determined depending on the intended purpose. For instance, it may be controlled to at most 0.012 micron as disclosed in U.S. Pat. No. 5,219,720, or the ratio of the distance between (111) major planes to the twinning plane interval may be controlled to at least 0.015 micron as disclosed in JP-A-5-249585.

It is desirable that in the present silver halide emulsion comprising {111} tabular silver halide grains, the {111} tabular grains account for 100 to 80%, preferably 100 to 90%, particularly preferably 100 to 95%, of all the grains in the emulsion on a projected area basis. When the total projected area of {111} tabular grains is smaller than 80% of the total projected area of all the grains, the advantages of {111} tabular grains (improvements in a speed/granularity ratio and sharpness) cannot be used to the full.

In the present emulsion comprising {111} tabular silver halide grains, it is desirable that the hexagonal {111} tabular grains having a ratio of adjacent sides (a longest side/shortest side ratio) in the range of 1.5 to 1 account for 100 to 50%, preferably 100 to 70%, particularly preferably 100 to 80%, of all the grains in the emulsion on a projected area basis. It is more desirable that the hexagonal {111} tabular grains having a ratio of adjacent sides in the range of 1.2 to 1 account for 100 to 50%, preferably 100 to 70%, particularly preferably 100 to 80%, of all the grains in the emulsion on a projected area basis. Mixing with {111} tabular grains other than the hexagonal ones is undesirable because the uniformity is lacking in the grains.

It is desirable that the average grain thickness of the {111} tabular crystals is from 0.05 to 0.2 micron, preferably from 0.05 to 0.15 micron. The term average grain thickness as used herein refers to the arithmetic mean of grain thickness values of the total {111} tabular grains in the emulsion. It is difficult to prepare the emulsion grains having an average grain thickness thinner than 0.05 micron. The emulsion grains having an average grain thickness thicker than 0.2 micron are undesirable.

The suitable average projected area diameter of the present {111} tabular grains is from 0.8 to 4 micron, preferably from 1 to 3.5 micron, particularly preferably from 1.2 to 3 micron. The term “average projected area diameter” used herein refers to the arithmetic mean of the projected area diameter values of the total {111} tabular grains in the emulsion. The average projected area diameter smaller than 0.8 micron is undesirable because of difficulty in achieving the present effects. And the average projected area diameter greater than 4 micron is also undesirable, because it causes deterioration in the resistance to damage by pressure.

The projected area diameter/thickness ratio of each silver halide grain is referred to as the aspect ratio. More specifically, the aspect ratio is a value obtained by dividing the diameter of a circle having the same area as the projected area of each silver halide grain by the grain thickness. As one example of a measurement method of the average aspect ratio, there is known the replica method in which the transmission electron photomicrographs of silver halide grains are taken and thereby the diameter of a circle having the same area as the projected area of each grain (projected area diameter) and the thickness of each grain are determined. In this method, the thickness is calculated from the length of the replica shadow.

In the present emulsion comprising {111} tabular silver halide grains, it is desirable that the {111} tabular grains having an average aspect ratio of 4 to 50 comprise 100 to 80% of the total silver halide grains in the emulsion on a projected area basis. In the emulsion more desirably used in the invention, the {111} tabular grains having an average aspect ratio of 6 to 50 comprise 100 to 80% of the total silver halide grains in the emulsion on a projected area basis. In particular, it is advantageous to the invention that the {111} tabular grains having an average aspect ratio of 8 to 50 comprise 100 to 80% of the total silver halide grains in the emulsion on a projected area basis.

Further, the suitable average aspect ratio for the total {111} tabular silver halide grains in the present emulsion is from 4 to 40, preferably from 6 to 40, more preferably from 12 to 35. The term average aspect ratio refers to the arithmetic mean of the aspect ratio values of total {111} tabular grains in the emulsion. Although the average grain thickness, the average aspect ratio and the homodisperse degree can be selected from their respective ranges mentioned above depending on the intended purposes, it is advantageous to the invention to use homodisperse {111} tabular grains having a small thickness and a high aspect ratio.

### EXAMPLE 1A

### Determination of Preferred {111} Adsorption

The preferred crystal faces to which a polymeric compound adsorbs is determined by a quantitative determination of the adsorption of the polymeric compound on cubic and on octahedral crystal faces using a Kubelka-Munk method as for example described by T. Tani, J. Imag. Sc, 1985, vol 29, 165.

Experimental Conditions

1. The Adsorption of the Polymeric Compound at {100} Faces.

The emulsions used are a cubic silver bromide emulsion with an average grain size of 0.70 micrometer and an octahedral silver bromide emulsion with an average grain size of 0.55 micrometer. The gelatin present in both silver bromide emulsions is a gelatin, which is oxidised to reduce the interaction of the gelatin with the grain surfaces. 25.0 gram emulsion was added in a stirred vessel at a temperature of 40° C. 150.0 ml of a 4% solution of the polymeric compound was added while maintaining a pH of 9. In a reference experiment 150 ml water was added. Next, at 1 minute intervals, 15 additions of 1.00 ml of a dye solution each containing 6.4 micro mol 3,3′-bis(4-sulfobuthyl)-9-methyl-thiacarbocyanide were done and after each addition the reflectance spectrum was recorded from 400 to 700 nm using a reflection spectrophotometer.

For the experiments in which the cubic emulsion was used, the D-band reflectance at 593 nm was measured. The reflectance values at 593 nm of the fifteen reflectance spectra were added up to obtain the value R⁵⁹³ₛ for samples and R⁵⁹³_{ref} for the reference.

The adsorption of the polymeric compound on {100} faces, ‘A_{{100}}’, is represented by an numerical value, calculated by the formula:
A_{{111}}=((R⁵⁹³ₛ/R⁵⁹³_{ref})−1)*100

For small values of the {100} face adsorption the examined polymer solution does not hinder the adsorption of dyes onto the {100} surface, whereas, at higher value the examined polymer was able to hinder the adsorption of dyes.

2. The Adsorption of the Polymeric Compound at {111} Faces.

For these measurements an octahedral emulsion was used, and the J-band reflectance at 620 nm of the dye at the surface was measured. The fifteen reflectance values at 620 nm of the fifteen reflectance spectra were added up to obtain the value R⁶²⁰ₛ for samples and R⁶²⁰ref for the reference.

The adsorption on {111} faces ‘A_{{111}}’ was calculated by the formula:
A_{{111}}=((R⁶²⁰ₛ/R⁶²⁰_{ref})−1)*40
3. A Numerical Value for the Preferred Adsorption

The preferred adsorption ‘S’ is calculated as
S=A_{{111}}−A_{{111}}

The preferred adsorption, measured at pH=9, of different gelatins are listed in table 1.

TABLE 1
Adsorption data of the different gelatins.

| | | | | | | S |
|---|---|---|---|---|---|---|
| gelatin/ | | | Mol Wt | | | (A₍₁₀₀₎- |
| aminoacid | | hydrolysis | (kD) | A₍₁₀₀₎ | A₍₁₁₁₎ | A₍₁₁₁₎) |
| lime bone gelatin | reference | — | 200 | 13.55 | 13.34 | 0.21 |
| acid bone gelatin | reference | acid | 30 | 14.52 | 14.54 | −0.02 |
| oxidized lime bone gelatin | reference | alkali | 30 | 5.45 | 5.16 | 0.29 |
| lime bone gelatin | reference | pronase | 6.6 | 16.34 | 16.81 | −0.47 |
| lime bone gelatin | inventive | trypsine | 9.5 | −0.09 | 10.93 | −11.02 |
| lime bone gelatin | inventive | trypsine | 6.4 | 0.09 | 10.93 | −10.84 |
| acid bone gelatin with | inventive | acid (before | 30 | 10.15 | 25.54 | −15.39 |
| C-terminal histidine | | coupling his) | | | | |
| oxidised lime bone gelatin | inventive | trypsine | 6.4 | 0.32 | 4.44 | −4.12 |
| oxidised acid bone gelatin | reference | acid | 30 | 5.44 | 5.16 | 0.28 |
| phthalated gelatin | reference | | 110 | 0.25 | 1.29 | −1.04 |
| Succinated gelatin | reference | | 143 | 0.45 | 2.88 | −2.43 |

### EXAMPLE 1B

### Measurement of the Homodispersity Parameter RDA

Homodispersity is expressed as RDA, the ratio between the distribution width at half peak height in nanometers and the average aspect ratio.

The distribution width is determined by disk centrifuge photosedimentometry using a CPS Instruments Inc., model DC 20.000.

1 g of the crystal emulsion is dissolved in 55 g of water and 5 g of ethanol. To this mixture is added 5 ml of a 1% (by weight) detergent solution and 5 ml of 0.05% (by weight) Pronase solution.

The mixture is incubated 10 minutes at 45 degrees Celsius. The injected volume is 0.05 ml. For the gradient 20 ml of a solution from 0% to 8% of sucrose and 1 ml of pure dodecane is used. The applied disc speed during the measurement is 3000 rpm. As reference size PVC latex spheres of 1.19 micron were used.

The aspect ratio is a value obtained by dividing the diameter of the largest surface area of the individual {111} tabular grain by the thickness thereof. The word “diameter,” used here, is the equivalent circular diameter (ECD), means the diameter of a circle, which has an area equal to the projected area of the grain, which is determined through microscope or electron microscope observation. Hence, an aspect ratio of 8 or more means that the diameter of that circle is 8 or more times greater than the thickness of the grain.

The homodispersity is expressed as RDA, being the ratio between the grain distribution width in nanometers at half peak height and the average aspect ratio.

### EXAMPLE 2

### Comparative

A {111} tabular silver bromide grain emulsion was prepared as follows:

A stirred reaction vessel contained a solution of 1200 ml water, 1.2 g of gelatine and 1.0 g potassium bromide. The pH of the solution was adjusted to 9.5 with NaOH and the temperature of the solution was maintained at 40° C. To this solution a 0.47 molar silver nitrate solution and a 0.82 molar potassium bromide solution containing 1.2% of a 200 kD lime bone gelatin were added at identical addition rates of 50 ml/min. The additions were simultaneously stopped after 50 seconds.

The temperature was increased to 70° C. After 40 minutes of ripening a non-oxidised lime bone gelatine was added, increasing the gelatine concentration to 22.5 weight %. Together with the gelatin an acid solution was added which lowered the pH to 5.0. A total of 1.50 mole of silver nitrate was then added in two separate growth stages. The amount of potassium bromide added during the two growth stages was such that the pBr was between 2.10 and 2.30. The addition rate of all additions was such that no re-nucleation occurred during the growth stage.

The grains were washed to remove the excess of salts and gelatine. After the washing 65 g of gelatine was added to the emulsion and the emulsion was stored at 6 degrees C. The resulting emulsion contained {111} tabular grains having an average thickness of 0.141 micron and an average ECD of 1.56 micron. The peak width at half height is 243 nm, resulting in a coefficient of variation (RDA) of 22.1.

### EXAMPLE 3

### Comparative

A {111} tabular silver bromide grain emulsion was prepared as in example 2, except that in the potassium bromide solution the 200 kD lime bone gelatine was replaced by a 30 kD lime bone gelatin, which was prepared by alkaline hydrolysis resulting in random cleaving of peptide bonds. The resulting emulsion contained {111} tabular grains having an average thickness of 0.134 micron and an average ECD of 1.68 micron. The peak width at half height is 235 nm, resulting in a coefficient of variation (RDA) of 18.8.

As can be expected from the lower molecular weight, the variation improved somewhat.

### EXAMPLE 4

### Comparative

A {11} tabular silver bromide grain emulsion was prepared as in example 2, except that in the potassium bromide solution the 200 kD lime bone gelatine was replaced by a 30 kD oxidised lime bone gelatin, said oxidation resulting in a methionine content of less than 5 micromoles per gram gelatin. The resulting emulsion contained {111} tabular grains having an average thickness of 0.118 micron and an average ECD of 1.75 micron. The peak width at half height is 275 nm, resulting in a coefficient of variation (RDA) of 18.5, showing some additional improvement in variation.

### EXAMPLE 5

### Inventive

A {111} tabular silver bromide grain emulsion was prepared as in example 2, except that in the potassium bromide solution the 200 kD lime bone gelatine was replaced by a 6.4 kD gelatin lime bone gelatin. The 6.4 kD gelatin was obtained by enzymatically hydrolyzing a lime bone gelatin with Trypsine. Trypsine selectively cleaves Arg-X and Lys-X peptide bonds resulting in a gelatin in which the C-terminal amino acid is a Lysine or Arginine. The resulting emulsion contained {111} tabular grains having an average thickness of 0.123 micron and an average ECD of 1.81 micron. The peak width at half height is 212 nm, resulting in a coefficient of variation (RDA) of 14.4, showing a remarkable improvement in variation.

### EXAMPLE 6

### Inventive

A {111} tabular silver bromide grain emulsion was prepared as in example 2, except that in the potassium bromide solution 6.4 kD inventive gelatin, obtained by hydrolysation with Trypsine, was added to a concentration of 1.2 weight %. In addition to this, 1.2 gram of said inventive gelatin of 6.4 kD was added in the stirred reaction vessel before the first silver nitrate and potassium bromide addition. The resulting emulsion contained {111} tabular grains having an average thickness of 0.120 micron and an average ECD of 1.78 micron. The peak width at half height is 228 nm, resulting in a coefficient of variation (RDA) of 15.4, still showing a remarkable improvement, in variation, but less than adding all inventive gelatin together with potassium bromide.

### EXAMPLE 7

### Inventive

A {111} tabular silver bromide grain emulsion was prepared as in example 2, except that in the potassium bromide solution the 200 kD lime bone gelatine was replaced by a 6.4 kD oxidized gelatin lime bone gelatin. The 6.4 KD gelatin was obtained by enzymatically hydrolyzing a lime bone gelatin with Trypsine. Trypsine selectively cleaves Arg-X and Lys-X peptide bonds resulting in a gelatin in which the C-terminal amino acid is a Lysine or Arginine. Oxidation resulted in a methionine content of less than 4 micro mol per gram gelatin. The resulting emulsion contained {111} tabular grains having an average thickness of 0.128 micron and an average ECD of 1.68 micron. The peak width at half height is 220 nm, resulting in a coefficient of variation (RDA) of 16.8, showing a remarkable improvement in variation. Remarkable is that the beneficial effect of the inventive gelatin on variation is less when applied to oxidised gelatin. Still, even oxidized inventive gelatins clearly improve the variation.

### EXAMPLE 8

### Comparative

A {111} tabular silver bromide grain emulsion was prepared as in example 2, except that in the potassium bromide solution the 200 kD lime bone gelatine was replaced by a 6.6 kD gelatin lime bone gelatin. The 6.6 KD gelatin was obtained by enzymatically hydrolyzing a lime bone gelatin with Pronase. Pronase a-selectively cleaves Ala-X, Gly-X, Leu-X, Ill-X, Pro-X or Val-X peptide bonds resulting in a gelatin in which only a few percent of the cleavages may result in a Lysine, Arginine or Histidine as N-terminal amino acid.

The resulting emulsion contained {111} tabular grains having an average thickness of 0.136 micron and an average ECD of 1.71 micron. The peak width at half height is 233 nm, resulting in a coefficient of variation (RDA) of 18.5, confirming that enzymatic hydrolysation should not be random but that cleaving specific sites, as done by Trypsine, is necessary.

### EXAMPLE 9

### Inventive

Preparation of the Gelatin

To a lime bone gelatin of 30 kD (example 3) L-Histidine groups were coupled to the carboxyl groups of the gelatin.

60 g of the acid bone gelatin (30 kD)) and 64 mmol L-Histidine methyl ester were dissolved into 400 ml of purified water. To this solution a THE solution of 27 mmol Dicyclohexylcarbodiimide was added drop wise. After 2 hours of reaction mixture was cooled and filtrated. Thereafter, the pH of the reaction mixture was increased to remove the ester protection group of L-Histidine and the gelatin solution was further purified by dialysis. See also The Practise of Peptide synthesis, M. Bodansky, A. Bodansky, Springer-Verlag, Berlin 1984, and Solid Phase Peptide synthesis, p 143.

A {111} tabular silver bromide grain emulsion was prepared as in example 2, except that in the potassium bromide solution the 200 kD lime bone gelatine was replaced by a 30 kD acid bone gelatin to which L-Histidine was coupled. The resulting emulsion contained {111} tabular grains having an average thickness of 0.133 micron and an average ECD of 1.67 micron with a coefficient of variation (peak width/AR) of 16.7, showing some additional improvement in variation.

Table 2 gives an overview of the results of the above experiments. The beneficial effect of the invention is clear when the ratio between the distribution width at half height and the average aspect ratio is calculated.

This is done because the RDA is dependant of the aspect ratio; higher aspect ratios have worse homodispersity. The volumetric grains size of the {111} tabular grains produced in experiments 2-9 was between 810 and 825 nm.

TABLE 2
Results experiments 2-9.

| | | Aspect | S | thick- | |
|---|---|---|---|---|---|
| | | ratio | (pref. | ness | |
| Exp. | Addition | (AR) | ads.) | (micron) | RDA |
| 2 | 200 kD comparative gelatin | 11.0 | 0.21 | 0.141 | 22.1 |
| | addition during nucleation | | | | |
| 3 | 30 kD comparative gelatin | 12.5 | −0.02 | 0.134 | 18.8 |
| | addition during nucleation | | | | |
| 4 | 30 kD oxidised comparative | 14.8 | 0.29 | 0.118 | 18.5 |
| | gelatin addition during | | | | |
| | nucleation | | | | |
| 5 | 6.4 kD inventive gelatin | 14.7 | −10.84 | 0.126 | 14.4 |
| | addition during nucleation | | | | |
| 6 | 6.4 kD inventive gelatin | 14.8 | −10.84 | 0.120 | 15.4 |
| | addition before and during | | | | |
| | nucleation | | | | |
| 7 | 6.4 kD oxidised inventive | 13.1 | −4.12 | 0.128 | 16.8 |
| | gelatin addition during | | | | |
| | nucleation | | | | |
| 8 | 6.6 kD comparative gelatin | 12.6 | −0.47 | 0.136 | 18.5 |
| | addition during nucleation | | | | |
| 9 | 30 kD inventive gelatin | 12.6 | −15.39 | 0.133 | 16.7 |
| | with a C-terminal histidine | | | | |

From the overview above it is clear that addition of a polylmer with a preferred absorption to the (111) crystal faces improves the homodispersity of thin {111} tabular silver halide emulsion remarkably while keeping desired aspect ratio.

1-19. (canceled)

20. A process for producing a {111} tabular silver halide emulsion in which an aqueous solution of a silver salt is combined with an aqueous solution of a halide salt forming {111} tabular silver halide grains in the presence of a water-soluble polymeric compound which has a preferred adsorption to {111} crystal faces of −3 or less as determined by subtracting the value for the adsorption to {111} crystal faces from the value for the adsorption to {100} crystal faces, measured at pH=9, said values being determined by the modified Kubelka-Munk method as described in T. Tani J. Imag. Sc 29 (1985) vol 29, 165 in the presence of the water soluble polymeric compound.

21. The process according to claim 20 in which the water-soluble polymeric compound is present in the nucleation step.

22. The process according to claim 20 in which the nucleation step is carried out at a pH of less than 6.

23. The process according to claim 20 in which the nucleation is carried out at a pH of 6 or more.

24. The process according to claim 21 in which the nucleation step is in the presence of a compound that has a preferred adsorption to {111} crystal faces of −6 or less.

25. The process according claim 21 in which the nucleation step is in the presence of a compound that is a polypeptide.

26. The process according claim 21 in which the nucleation step is in the presence of a compound that is selected from a natural gelatine, a synthetic gelatine, a modified gelatine and a recombinant gelatine.

27. The process according to claim 26 in which the gelatine has an average molecular weight of less than 50 kilo Dalton.

28. A process according to claim 26 in which the gelatine has a molecular weight of 5 to 25 kilo Dalton.

29. The process according to claim 21 wherein the water-soluble polymeric compound is added simultaneously with the silver salt and the halide salt in the nucleation step.

30. The process according to claim 21 in which the nucleation step is in the presence of a compound that is a polypeptide comprising an amino acid selected from arginine, lysine, hydroxylysine and histidine as the carboxy-terminal amino acid.

31. The process according to claim 21 in which the nucleation step is in the presence of a compound that is a polypeptide in which at least one terminal side of the polypeptide comprises an amino acid ‘A’ with an amine containing restgroup and an amino acid ‘B’ with a carboxyl containing restgroup said amino acids ‘A’ and ‘B’ being separated from each other by at most 4 amino acids, preferably by at most 2 amino acids most preferably by at most 1 amino acid.

32. The process according to claim 31 in which the nucleation step is carried out at a pH of 7 or more, preferably at a pH of at least 8, more preferably at a pH between about 8 and 11 in the presence of a polypeptide in which amino acid ‘A’ is arginine or lysine.

33. The process according to claim 30 in which the nucleation step is carried out at a pH of 7 or more in the presence of a polypeptide having an arginine or lysine as the carboxy-terminal amino acid.

34. The process according to claim 21 wherein in the nucleation step the water-soluble polymeric compound is present in an amount of about 0.01 to 0.2 mol per mol silver.

35. A {111} tabular silver halide emulsion wherein at least 60% of the total projected grain area of said silver halide grains are {111} tabular silver halide grains with a silver bromide content of at least 50% obtainable with the method according to claim 20.

36. The {111} tabular silver halide emulsion according to claim 35 wherein the {111} tabular silver halide grains have an average aspect ratio of 6 to 40 and a thickness of less than 0.2 micron and more than 0.05 micron.

37. The {111} tabular silver halide emulsion according to claim 35 having a homodispersity of less than 18 expressed as RDA.

38. Photographic material comprising on a support at least one layer comprising a {111} tabular silver halide emulsion according to claim 35.
